(19) United States
(12) Patent Application Publication
(10) Pub. No.: US 2006/0291607 A1
(43) Pub. Date: Dec. 28, 2006

(54) Target apparatus

(76) Inventors: Bong Hwan Hong, Seoul (KR); Jong Seo Chai, Seoul (KR); Min Yong Lee, Seoul (KR); Won Taek Hwang, Seoul (KR); Min Goo Hur, Gwangmyung-city (KR); Sang Wook Kim, Curi-city (KR); Dong Hyun An, Seoul (KR); In Soo Jung, Seoul (KR); Hong Suk Chang, Yongin-city (KR); Joon Sun Kang, Seoul (KR); Seong Seok Hong, Guri-city (KR); Yu Seok Kim, Seoul (KR); Tae Keun Yang, Seoul (KR); Jung Hwan Kim, Seoul (KR)

Correspondence Address: CANTOR COLBURN, LLP, 55 GRIFFIN ROAD SOUTH, BLOOMFIELD, CT, 06002, US

(21) Appl. No.: 11/471,263

(22) Filed: Jun. 20, 2006

(30) Foreign Application Priority Data
Jun. 21, 2005 (KR) 10-2005-0053562

(51) Int. Cl. G21G 1/06

(52) U.S. Cl. 376/168

(57) ABSTRACT

Provided is a target apparatus of high durability so that a thin film is not deformed or damaged under an environment of high temperature and high pressure generated during a nuclear reaction between proton and H₂¹⁸O concentrate, and a productivity of ¹⁸F can be increased. The target apparatus includes a cavity member having a cavity, in which H₂¹⁸O concentrate is received, for producing ¹⁸F using a nuclear reaction between proton irradiated onto the H₂¹⁸O concentrate in the cavity and the H₂¹⁸O concentrate. The cavity member includes: a front opening and a rear opening facing opposite directions to each other on the irradiation path of the proton, and connected to the cavity so that the cavity can be communicated with the outside; a front thin film and a rear thin film disposed to block the front opening and the rear opening, respectively; and a front reinforcing member and a rear reinforcing member coupled to the cavity member so as to support the front thin film and the rear thin film in order to prevent the front and rear thin films from being swelled due to a pressure rising in the cavity during the nuclear reaction, wherein the front reinforcing member includes a plurality of penetration holes penetrating the front reinforcing member in the irradiation direction of the proton.

### CROSS-REFERENCE TO RELATED PATENT APPLICATIONS

This application claims the benefit of Korean Patent Application No. 10-2005-0053562, filed on Jun. 21, 2005, in the Korean Intellectual Property Office, the disclosure of which is incorporated herein in its entirety by reference.

### BACKGROUND OF THE INVENTION

1. Field of the Invention

The present invention relates to a target apparatus, and more particularly, to a target apparatus having an improved structure so that a thin film is not deformed or damaged under an environment of high pressure and high temperature generated when a nuclear reaction between proton and H₂¹⁸O concentrate occurs.

2. Description of the Related Art

Positron Emission Tomographys (PETs) can be widely used to diagnose tumors and a variety of diseases in advance.

A range of diagnosis using the PET is being expanded, and accordingly, proton emitting radio-pharmaceutical marking various proton emitting isotopes are being developed. For example, FDG (2-[18F]Fluoro-2-deoxy-D-glucose) is used to diagnose cancers, and L-[11C-methyl]methionine can be used to diagnose brain tumor.

In addition, isotopes for PET can be ¹⁸F, ¹¹C, ¹⁵O, and ¹³N, and target apparatuses which are specially made are used to generate the isotopes, respectively. FIG. 1 shows an example of conventional target apparatus for generating ¹⁸F among the above isotopes.

Referring to FIG. 1, the conventional target apparatus 1 for generating ¹⁸F includes a cavity member 70 having a cavity 71 receiving H₂¹⁸O concentrate that is H₂O including 95% or more concentrated H₂¹⁸O and having an opened side, and a space portion 72 in which cooling water flows, a thin film 73 covering the opening side of the cavity member 70, and another thin film 74 separated from the thin film 73 frontward and forming a space portion 75, in which helium flows, with the thin film 73. The proton beam is generated and irradiated by a particle accelerator such as a cyclotron, and a front portion of the thin film 74 is vacuumed.

In the target apparatus 1 having the above structure, when the proton beam generated by the particle accelerator such as the cyclotron is irradiated toward the H₂¹⁸O concentrate received in the cavity 71, the proton beam passes through the thin films 73 and 74, then a nuclear reaction occurs between the proton and the H₂¹⁸O concentrate. According to the nuclear reaction, ¹⁸F is produced. In addition, while the proton beam passes through the thin films 73 and 74, some of the proton energy is absorbed by the thin films 73 and 74, and thus, temperatures of the thin films 73 and 74 rise. The heated thin films 73 and 74 are cooled by helium gas that is induced and discharged along the directions denoted by arrows in FIG. 1 and flows in the space portion 75. In addition, the energy of the proton beam is absorbed by the H₂¹⁸O concentrate after passing through the thin films 73 and 74, so the energy performs the nuclear reaction with the H₂¹⁸O concentrate. Accordingly, a temperature of H₂¹⁸O concentrate rises rapidly, and the H₂¹⁸O concentrate is induced and discharged along the direction denoted by the arrows in FIG. 1 to be forcedly cooled by the cooling water flowing in the space portion 72.

However, in the target apparatus 1 having the above structure, since a thickness of a wall between the cavity 71 and the space portion 72 in the cavity member 70 is generally 1 mm or thicker, there is a limitation to cool down the H₂¹⁸O concentrate to an appropriate temperature by the heat transfer with the cooling water because of the thick wall.

In addition, due to the limitation in the cooling performance, the temperature of the H₂¹⁸O concentrate rises rapidly during the nuclear reaction between the proton and the H₂¹⁸O concentrate, and a phase transformation of the H₂¹⁸O concentrate accompanied with rising of pressure under the high temperature occurs. Therefore, H₂¹⁸O vapor of high temperature and high pressure and liquid H₂¹⁸O concentrate commonly exist in the cavity 71, and accordingly, the thin film 73 is deformed due to the high pressure under the high temperature. Moreover, if the loads are applied to the thin film 73 repeatedly when the target apparatus 1 is continuously used, the thin film 73 may be damaged.

Even though the thin film 73 is not damaged, the thin film 73 may be swelled and deformed. Then, an amount of the H₂¹⁸O concentrate that should fill the cavity 71 is increased as much as the swelled amount of the thin film 73, and thus, since the price of H₂¹⁸O concentrate is expensive, the increase of the H₂¹⁸O concentrate causes an increase in the fabrication costs of ¹⁸F.

In addition, during the nuclear reaction between the proton and H₂¹⁸O concentrate, H₂¹⁸O vapor is generated and liquid type H₂¹⁸O concentrate is reduced, and accordingly, water level of the liquid H₂¹⁸O concentrate is lowered. When the level of liquid H₂¹⁸O concentrate is lowered, not all of the energy of the proton is absorbed and the proton passes through the cavity 71 since the concentration of H₂¹⁸O vapor is smaller than that of the liquid H₂¹⁸O concentrate. As described above, when the proton passes the cavity 71, the nuclear reaction cannot be generated sufficiently. Therefore, desired amount of ¹⁸F cannot be produced. In addition, more heat is generated when the proton is irradiated to H₂¹⁸O vapor than when the proton is irradiated to the liquid H₂¹⁸O concentrate, and thus, the temperature and pressure in the cavity 71 are increased and the thin film 73 may be damaged easily.

### SUMMARY OF THE INVENTION

The present invention provides a target apparatus having an improved structure so that a thin film is not deformed or damaged under an environment of high temperature and high pressure generated during a nuclear reaction between proton and H₂¹⁸O concentrate, and a productivity of ¹⁸F can be increased.

According to an aspect of the present invention, there is provided a target apparatus including: a cavity member having a cavity, in which H₂¹⁸O concentrate is received, for producing ¹⁸F using a nuclear reaction between proton irradiated onto the H₂¹⁸O concentrate in the cavity and the H₂¹⁸O concentrate, wherein the cavity member includes: a front opening and a rear opening facing opposite directions to each other on the irradiation path of the proton, and connected to the cavity so that the cavity can be communicated with the outside; a front thin film and a rear thin film disposed to block the front opening and the rear opening, respectively; and a front reinforcing member and a rear reinforcing member coupled to the cavity member so as to support the front thin film and the rear thin film in order to prevent the front and rear thin films from being swelled due to a pressure rising in the cavity during the nuclear reaction, wherein the front reinforcing member includes a plurality of penetration holes penetrating the front reinforcing member in the irradiation direction of the proton.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic cross-sectional view of a target apparatus according to the conventional art;

FIG. 2 is a schematic cross-sectional view of a target apparatus according to an embodiment of the present invention;

FIG. 3 is a view illustrating energy loss of proton in both cases where a front lattice of a front reinforcing member is formed as a concave and formed as a plane in the target apparatus of FIG. 2;

FIG. 4 is an exploded perspective view of the target apparatus of FIG. 2; and

FIG. 5 is a perspective view of a cavity member shown in FIG. 4 viewed from rear portion of the cavity member.

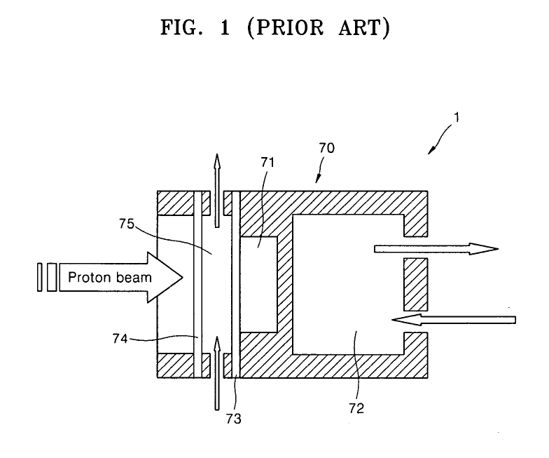

### DETAILED DESCRIPTION OF THE INVENTION

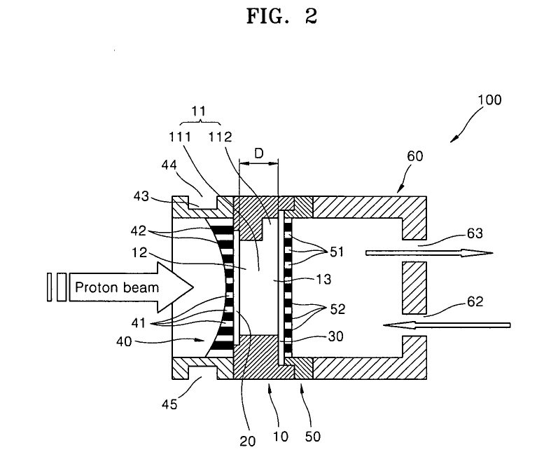

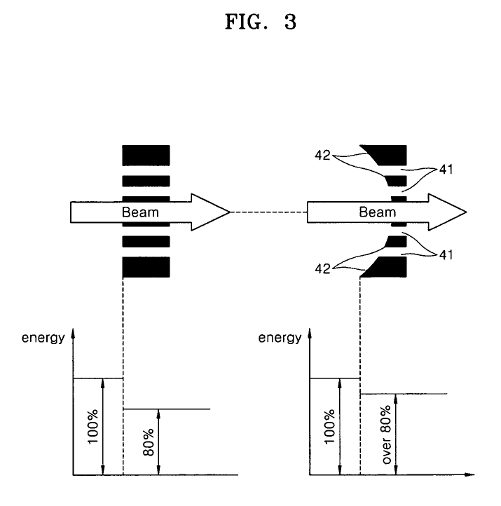

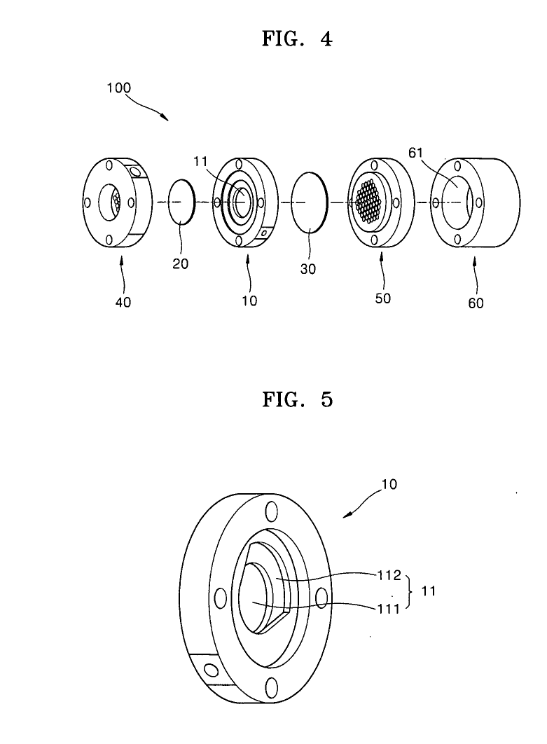

FIG. 2 is a schematic cross-sectional view of a target apparatus according to an embodiment of the present invention, FIG. 3 is a view illustrating energy loss of proton in both cases where a front lattice of a front reinforcing member is formed as a concave and formed as a plane in the target apparatus of FIG. 2, FIG. 4 is an exploded perspective view of the target apparatus of FIG. 2, and FIG. 5 is a perspective view of a cavity member shown in FIG. 4 viewed from rear portion of the cavity member.

Referring to FIGS. 2 through 5, a target apparatus 100 according to the present invention is to produce ¹⁸F using a nuclear reaction between proton beam irradiated to H₂¹⁸O concentrate and the H₂¹⁸O concentrate. The target apparatus 100 includes a cavity member 10, a front thin film 20 and a rear thin film 30, a front reinforcing member 40 and a rear reinforcing member 50, and a cooling member 60.

The cavity member 10 includes a cavity 11, a front opening 12, and a rear opening 13. The cavity member 10 is formed of a metal such as Ti.

The cavity 11 includes the H₂¹⁸O concentrate. The H₂¹⁸O concentrate is H₂O, in which 95% or more H₂¹⁸O is concentrated. The cavity 11 includes a cavity main body 111 and an auxiliary cavity portion 112.

The cavity main body 111 has a circular cross-section that is perpendicular to the irradiation direction of the proton.

The auxiliary cavity portion 112 extends from a rear portion of the cavity main body 111 to an upper portion. The auxiliary cavity portion 112 has a fan-shape cross-section that is perpendicular to the irradiation direction of the proton. In a case where the heat is generated by the nuclear reaction between the proton and the H₂¹⁸O concentrate, cooling water flowing in a space portion of the cooling member 60 that will be described later can cool down a larger area as much as the cross-sectional area of the auxiliary cavity portion 112 than the case without the auxiliary cavity portion 112, and thus, the cooling performance of the target apparatus 100 can be improved. In addition, in a case where the H₂¹⁸O concentrate is vaporized by the nuclear reaction between the proton and the H₂¹⁸O concentrate, since the H₂¹⁸O vapor can be collected in the auxiliary cavity portion 112, the decrease of level of the H₂¹⁸O concentrate can be prevented.

Since the auxiliary cavity portion 112 is formed as a fan shape, entire volume of the cavity 11 can be minimized and a heat transferred area with the cooling water can be increased. In addition, as shown in FIGS. 2 and 3, since the cavity 11 is formed as steps, the H₂¹⁸O vapor is collected on the upper portion of the auxiliary cavity portion 112, and the collected H₂¹⁸O vapor is cooled to be converted into the H₂¹⁸O concentrate easily.

The volume of the cavity 11 is fixed about 1.5 cc because the H₂¹⁸O concentrate 1.5 cc is a minimum volume to generate the nuclear reaction and the H₂¹⁸O concentrate is expensive. A depth (D) of the cavity 11 may be set appropriately so that all of the proton that is irradiated by a particle accelerator such as a cyclotron and passes through the front thin film 20 can be absorbed by the H₂¹⁸O concentrate received in the cavity 11.

The front opening 12 and the rear opening 13 face opposite directions to each other on the irradiation path of the proton. The front opening 12 and the rear opening 13 are connected to the cavity 11 so that the cavity 11 can communicate with the outside.

The front opening 12 has the same cross-section as that of the cavity main body 111, and the rear opening 13 has the cross-section corresponding to a combined shape of the cross-sections of the cavity main body 111 and the auxiliary cavity portion 112. The proton is irradiated toward the cavity 11 through the front opening 12, and the energy of the irradiated proton is absorbed by the H₂¹⁸O concentrate received in the cavity 11.

The front thin film 20 and the rear thin film 30 are disposed to block the front opening 12 and the rear opening 13, respectively. The H₂¹⁸O concentrate received in the cavity 11 does not leak out of the cavity 11 due to the front thin film 20 and the rear thin film 30. The front thin film 20 and the rear thin film 30 are formed of a metal such as Ti, and thicknesses of the front and rear thin films 20 and 30 are generally tens of □, respectively. In the present embodiment, thicknesses of the front thin film 20 and of the rear thin film 30 are 50□, respectively. Since the rear thin film 30 is much thinner than the conventional wall thickness, that is, 1 mm, the heat generated during the nuclear reaction can be efficiently cooled by the cooling water flowing in the cooling member 60 that will be described later.

The front reinforcing member 40 and the rear reinforcing member 50 are coupled to the cavity member 10 so as to support the front thin film 20 and the rear thin film 30, respectively. Accordingly, the front thin film 20 is disposed between the front reinforcing member 40 and the cavity member 10, and the rear thin film 30 is disposed between the rear reinforcing member 50 and the cavity member 10 as shown in FIG. 2. In addition, the front thin film 20 and the rear thin film 30 are sealed with the cavity 11 by a sealing member (not shown) such as polyethylene. The front reinforcing member 40 and the rear reinforcing member 50 are disposed on the irradiation path of the proton beam. The front reinforcing member 40 and the rear reinforcing member 50 are formed of a metal such as Al.

The front reinforcing member 40 and the rear reinforcing member 50 prevent the front thin film 20 and the rear thin film 30 from swelling due to the pressure rising in the cavity 11 during the nuclear reaction between the proton beam and the H₂¹⁸O concentrate. That is, the phase of H₂¹⁸O concentrate is transformed due to the heat generated during the nuclear reaction and some of the H₂¹⁸O concentrate is converted into H₂¹⁸O vapor. In addition, the front thin film 20 and the rear thin film 30 are swelled by the pressure rising generated by the H₂¹⁸O vapor toward the opposite directions to each other, that is, the directions of the front opening 12 and the rear opening 13. However, since the reinforcing members 40 and 50 are coupled to the thin films 20 and 30 to support the thin films 20 and 30, the deformation of the thin films 20 and 30 can be prevented. As described above, the thin films 20 and 30 are not deformed or damaged under the environment of high temperature and pressure generated during the nuclear reaction using the reinforcing members 40 and 50, and the volume formed by the cavity 11 and the thin films 20 and 30 is not changed.

A plurality of penetration holes 41 penetrating the front reinforcing member 40 are formed in the front reinforcing member 40 in the irradiation direction of the proton. In addition, entire area of the penetration holes 41 formed on a portion corresponding to the front opening 12 of the cavity member 10 occupies 80% or more of the entire area of the front opening 12. The proton cannot pass through a front lattice 42, that is, potion of the front reinforcing member 40 between the penetration holes 41, and thus, the energy loss occurs. Therefore, if the entire area of the penetration holes 41 occupies less than 80% of the entire area of the front opening 12, the energy is excessively lost and the productivity of ¹⁸F may be degraded.

The portion of the front reinforcing member 40 to which the proton is irradiated, that is, the front lattice 42, is formed as concave portions with respect to the irradiation direction of the proton. The concave front lattice 42 is formed due to following reasons. If the front lattice 42 is formed as a plane with respect to the irradiation direction of the proton, the energy loss of the proton is increased as shown in FIG. 3, and more heat is generated as much as the lost energy. A center portion of the front lattice 42 may have a thickness of 0.5 mm or thinner, and the outermost portion of the front lattice 42 has a thickness of 1 mm. When the entire front lattice 42 is concavely formed as described above, a strength of the concave structure can be improved, the energy loss of the proton can be reduced, and the heat generated during the nuclear reaction can be cooled efficiently.

The front reinforcing member 40 includes a ring-shaped space portion 43, in which the cooling water flows. An inlet 44, through which the cooling water can be induced, is formed on a side of the ring-shaped space portion 43, and an outlet 45, through which the cooling water can be discharged, is formed the other side. The heat generated on the front lattice 42 when the proton is irradiated onto the front reinforcing member 40 and the heat generated during the nuclear reaction can be cooled down by the cooling water flowing in the space portion 42 through the front lattice 42.

The rear reinforcing member 50 includes a plurality of penetration holes 51 penetrating the rear reinforcing member 50 in the irradiation direction of the proton. Rear lattice 52, that is, the portion of the rear reinforcing member 50 formed between the penetration holes 51, increases a heat dissipating area, and forms a whirl in the cooling water that forcedly circulates in the space portion 61 of the cooling member 60 in order to dissipate the heat generated during the nuclear reaction efficiently.

The cooling member 60 is coupled to the rear reinforcing member 50. The cooling member 60 includes a space portion 61, in which the cooling water is forcedly circulated by an impinging jet, in order to cool the heat generated during the nuclear reaction between the proton passing the rear thin film 30 and the H₂¹⁸O concentrate received in the cavity 11. The cooling water is induced into the space portion 61 through the inlet 62 by an additional pumping apparatus (not shown) as denoted by arrow in FIG. 2, and the induced cooling water is discharged out of the space portion 61 through the outlet 63.

The front reinforcing member 40, the cavity member 10, the rear reinforcing member 50, and the cooling member 60 are coupled integrally with each other by bolts.

Hereinafter, processes of producing ¹⁸F using the target apparatus 100 according to the present embodiment will be described as follows, and effects of the invention will be described in detail.

When the particle accelerator such as a cyclotron generates proton having an appropriate energy level and irradiates the generated proton to the target apparatus 100 of FIG. 2, some of the proton cannot pass through the front lattice 42 of the front reinforcing member 40 but is absorbed, and the other proton passes the penetration holes 41 of the front reinforcing member 40. In addition, after passing the penetration holes 41 of the front reinforcing member 40, some of the energy of the proton is absorbed by the front thin film 20 while the proton passes through the front thin film 20, and remaining energy of the proton is absorbed by the H₂¹⁸O concentrate received in the cavity 11 of the cavity member 10. As described above, when the proton is irradiated onto the H₂¹⁸O concentrate, the nuclear reaction between the proton and the H₂¹⁸O concentrate occurs, and accordingly, ¹⁸F is produced. In addition, when the proton is irradiated, the heat generated on the front lattice 42 of the front reinforcing member 40 is cooled by the cooling water flowing in the ring-shaped space portion 43 of the front reinforcing member 40, and the heat generated during the nuclear reaction between the proton and the H₂¹⁸O concentrate is cooled by the cooling water flowing in the space portion 61 of the cooling member 60.

Meanwhile, in the nuclear reaction between the proton and the H₂¹⁸O concentrate, the heat of high temperature is generated, and the heat is generally cooled by the cooling water flowing in the space portion 61 of the cooling member 60. However, in the target apparatus 100 of the present embodiment, the heat transferred through the rear thin film 30 having the thickness of 50□ is cooled by the cooling water, unlike the conventional cooling method, in which the heat is transferred through the wall having the thickness of 1 mm or thicker. In addition, the heat dissipating area can be increased by the rear lattice 52 of the rear reinforcing member 50, and the rear lattice 52 forms a whirl when the cooling water is forcedly circulated. Also, in the present embodiment, a rear portion of the cavity 11 includes both of the cavity main body 111 and the auxiliary cavity portion 112, and thus, the heat dissipating area can be increased. Therefore, the heat generated during the nuclear reaction between the proton and the H₂¹⁸O concentrate can be efficiently cooled. Even when the H₂¹⁸O concentrate is vaporized by the heat generated in the nuclear reaction, the H₂¹⁸O vapor can be converted into the liquid phase within a short time by the cooling water.

In particular, since the cavity 11 includes the cavity main body 111 having a circular cross-section and the auxiliary cavity portion 112 having a fan-shaped cross-section, the H₂¹⁸O vapor can be collected in the auxiliary cavity portion 112 when the H₂¹⁸O concentrate is vaporized. Thus, the level of liquid H₂¹⁸O concentrate is not lowered unlike in the conventional art, in which the auxiliary cavity portion 112 is not formed. If the level of liquid H₂¹⁸O concentrate is not lowered, the productivity of ¹⁸F can be improved higher than that of the conventional art. When the proton passes through the H₂¹⁸O vapor in a status where the level of liquid H₂¹⁸O concentrate is lowered, not all of the energy of the proton is absorbed and the proton passes through the rear thin film since the density of the H₂¹⁸O vapor is lower than that of the H₂¹⁸O concentrate. Thus, the nuclear reaction of desired level cannot be generated, and accordingly, a desired amount of ¹⁸F cannot be produced. In addition, referring to FIG. 2, since the cavity 11 is stepped shape, it is advantageous to cool the H₂¹⁸O vapor collected in the upper portion of the auxiliary cavity portion 112 to convert the vapor into the liquid H₂¹⁸O concentrate.

In addition, in the nuclear reaction between the proton and the H₂¹⁸O concentrate, the temperature of the H₂¹⁸O concentrate rises instantly, and thus, some of the H₂¹⁸O concentrate is converted into the H₂¹⁸O vapor. Then, the inside of the cavity 11 becomes the status of high temperature and high pressure, and the front thin film 20 and the rear thin film 30 are swelled by the pressure. However, according to the target apparatus 100 of the present embodiment, since the front reinforcing member 40 and the rear reinforcing member 50 are formed to support the front thin film 20 and the rear thin film 30, the swelling of the front and rear thin films 20 and 30 can be prevented, and the damage of the front and rear thin films 20 and 30 can be prevented. Therefore, life spans of the front and rear thin films 20 and 30 can increase, and thus, the increase of the usage amount of expensive H₂¹⁸O concentrate due to the deformation of the front and rear thin films can be prevented.

In addition, since the front reinforcing member 40 having the front lattice 42 is formed as the concave shape, the energy loss is generated less than that of the conventional plane structure. Moreover, the heat is less absorbed by the lattice 42, and thus, the heat generation from the front lattice 42 can be reduced. Therefore, the heat transferred from the center portion of the front lattice 42 toward the outer portions can be efficiently cooled by the cooling water flowing in the ring-shaped space portion 43. Therefore, the center portion of the front lattice 42 is not damaged. In addition, since the entire shape of the front lattice 42 is formed as an arch, the strength of the front lattice 42 can be improved.

According to the structure of the target apparatus of the present embodiment, the heat generated during the nuclear reaction between the proton and the H₂¹⁸O concentrate can be efficiently dissipated, the vaporization of the H₂¹⁸O concentrate during the nuclear reaction can be restrained. Even when some of the concentrate is vaporized, the H₂¹⁸O vapor can be rapidly condensed, and thus, the level of H₂¹⁸O concentrate received in the cavity 11 is not lowered. Therefore, the productivity of ¹⁸F can be improved.

In addition, since the front and rear reinforcing members are installed to support the front and rear thin films respectively, the deformation of the front and rear thin films during the nuclear reaction can be prevented, and the damage of the front and rear thin films can be prevented. Thus, the durability of the target apparatus can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A target apparatus comprising:
a cavity member having a cavity, in which H₂¹⁸O concentrate is received, for producing ¹⁸F using a nuclear reaction between proton irradiated onto the H₂¹⁸O concentrate in the cavity and the H₂¹⁸O concentrate,
wherein the cavity member comprises:
a front opening and a rear opening facing opposite directions to each other on the irradiation path of the proton, and connected to the cavity so that the cavity can be communicated with the outside;
a front thin film and a rear thin film disposed to block the front opening and the rear opening, respectively; and
a front reinforcing member and a rear reinforcing member coupled to the cavity member so as to support the front thin film and the rear thin film in order to prevent the front and rear thin films from being swelled due to a pressure rising in the cavity during the nuclear reaction, wherein the front reinforcing member includes a plurality of penetration holes penetrating the front reinforcing member in the irradiation direction of the proton.

2. The target apparatus of claim 1, wherein the rear reinforcing member includes a plurality of penetration holes penetrating the rear reinforcing member in the irradiation direction of the proton.

3. The target apparatus of claim 2, wherein an entire area of the penetration holes formed on a portion of the front reinforcing member corresponding to the front opening of the cavity member occupies 80% or more of an entire area of the front opening.

4. The target apparatus of claim 1, wherein a portion of the front reinforcing member, to which the proton is irradiated, is concave-shaped with respect to the irradiation direction of the proton.

5. The target apparatus of claim 1, wherein the cavity of the cavity member comprises:
a cavity main body; and
an auxiliary cavity portion extending from a rear portion of the cavity main body toward an upper portion.

6. The target apparatus of claim 5, wherein the cavity main body has a circular cross-section that is perpendicular to the irradiation direction of the proton, and the auxiliary cavity portion has a fan-shaped cross-section that is perpendicular to the irradiation direction of the proton.
